(19) United States
(12) Patent Application Publication
(10) Pub. No.: US 2026/0103205 A1
(43) Pub. Date: Apr. 16, 2026

(54) METHOD AND APPARATUS FOR PATH PREDICTION OF VEHICLE BASED ON DRIVER INTENT

(71) Applicants: Hyundai Motor Company, Seoul (KR); Kia Corporation, Seoul (KR)

(72) Inventor: Na Hyun Kweon, Hwaseong (KR)

(21) Appl. No.: 19/290,708

(22) Filed: Aug. 5, 2025

(30) Foreign Application Priority Data
Oct. 11, 2024 (KR) 10-2024-0138535

(51) Int. Cl. B60W 50/00; B60W 50/10

(52) U.S. Cl. CPC B60W 50/0097; B60W 50/10; B60W 2520/14; B60W 2540/18; B60W 2552/53

(57) ABSTRACT

A method and apparatus for path prediction of a vehicle are carried out based on intent of a driver. The method for predicting a path of the vehicle includes: obtaining road information and driving information of the vehicle; determining a driving intent of a driver based on at least one of a steering angle, a steering angle velocity, or a yaw rate of the vehicle; determining a predicted path-generation time based on the driving intent of the driver; and generating a derived path based on the predicted path-generation time.

### CROSS-REFERENCE TO RELATED APPLICATION(S)

This application claims under 35 U.S.C. § 119(a) the benefit of Korean Patent Application No. 10-2024-0138535, filed on Oct. 11, 2024 in the Korean Intellectual Property Office, the entire contents of which are incorporated herein by reference.

### BACKGROUND

### (a) Technical Field

The present disclosure relates to a method and apparatus for path prediction of a vehicle based on a driver's intent, more particularly, to the method and apparatus for improving path prediction accuracy by changing a predicted path-generation time based on a changed driver's driving intent.

### (b) Description of the Related Art

Various advanced driver assistance systems (ADAS) have been developed to assist drivers in complex traffic situations or to enable autonomous driving. A typical driver assistance system predicts the path of a subject vehicle for path planning, collision avoidance decisions, etc. For example, a driver assistance system may use the predicted path to calculate the probability of a collision between the subject vehicle and a neighboring object and warn the driver in advance and/or execute control to perform an evasive action.

An autonomous driving system predicts the path of the subject vehicle by using a physics-based model that is based on the driving information of the vehicle, including velocity, acceleration, yaw rate, steering angle, steering angle velocity, etc. In addition, the autonomous driving system can improve path prediction accuracy by using a maneuver-based model that is based on road information including lane information, etc. To reflect the characteristics of both physics-based and maneuver-based models, existing autonomous driving systems have used the two models to predict the respective paths and combined the predicted path with the physics-based model and the predicted path with the maneuver-based model to predict the path.

However, the above-described method of generating predicted paths may predict impossible paths for the driver to follow, at least because it does not take into account driver intent, which results in inaccurate path predictions.

### SUMMARY

The present disclosure provides a method and apparatus that can generate a natural predicted path in situations where a driver's intent changes by determining a predicted path-generation time based on the driver's intent.

The present disclosure aims to provide a path prediction method and apparatus that reflects road conditions and vehicle driving status by performing path prediction of an autonomous vehicle based on a driver's intent (hereinafter, also referred to as driving intent).

Technical objects to be achieved by the present disclosure are not limited to those described above, and other technical objects not mentioned above may also be clearly understood from the detailed descriptions given below by those skilled in the art to which the present disclosure belongs.

According to the present disclosure, a method for predicting a path of a vehicle includes steps of: obtaining, by at least one processor, road information and driving information of the vehicle; determining, by the at least one processor, a driving intent of a driver based on at least one of a steering angle, a steering angle velocity, or a yaw rate of the vehicle; determining, by the at least one processor, a predicted path-generation time based on the driving intent of the driver; and generating, by the at least one processor, a derived path based on the predicted path-generation time.

According to at least one aspect, the present disclosure provides a method for predicting a path of a vehicle, the method comprising: obtaining road information and driving information of the vehicle; determining a driving intent of a driver based on at least one of a steering angle, a steering angle velocity, or a yaw rate of the vehicle; determining a predicted path-generation time based on the driving intent of the driver; and generating a derived path based on the predicted path-generation time.

According to the present disclosure, an apparatus for predicting a path of a vehicle includes: at least one memory configured to store instructions; and at least one processor, wherein the at least one processor is configured to execute the instructions stored in the at least one memory for causing the processor to: obtain road information and driving information of the vehicle; determine a driving intent of a driver based on at least one of a steering angle, a steering angle velocity, or a yaw rate of the vehicle; determine a predicted path-generation time based on the driving intent of the driver; and generate a derived path based on the predicted path-generation time.

According to another aspect, the present disclosure provides an apparatus for predicting a path of a vehicle, comprising: at least one memory configured to store instructions; and at least one processor, wherein the at least one processor executes the instructions for causing the processor to perform the steps of: obtaining road information and driving information of the vehicle; determining a driving intent of a driver based on at least one of a steering angle, a steering angle velocity, or a yaw rate of the vehicle; determining a predicted path-generation time based on the driving intent of the driver; and generating a derived path based on the predicted path-generation time.

According to at least one embodiment, by determining the predicted path-generation time based on the driver's driving intent, the present disclosure can predict a smooth and natural path even in situations where the driver's driving intent changes.

According to another embodiment, by performing a path prediction of an autonomous vehicle based on a driver's driving intent, the present disclosure can reflect road conditions and vehicle driving status.

A vehicle may include the above-described apparatus.

According to the present disclosure, a non-transitory computer readable medium containing program instructions executed by a processor includes: program instructions that obtain road information and driving information of a vehicle; program instructions that determine a driving intent of a driver based on at least one of a steering angle, a steering angle velocity, or a yaw rate of the vehicle; program instructions that determine a predicted path-generation time based on the driving intent of the driver; and program instructions that generate a derived path based on the predicted path-generation time.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a schematic block diagram of a path prediction apparatus (100) according to at least one embodiment of the present disclosure.

FIG. 2 illustrates an example state flow diagram used by the path prediction apparatus (100) according to at least one embodiment of the present disclosure to determine driving intent.

FIG. 3 illustrates an example state flow diagram used to determine a predicted path-generation time, according to at least one embodiment of the present disclosure.

FIG. 4 is a flowchart of a path prediction process using a physics-based model, according to at least one embodiment of the present disclosure.

FIG. 5A, FIG. 5B, and FIG. 5C are diagrams illustrating derived paths generated by a path prediction apparatus according to at least one embodiment of the present disclosure.

FIG. 6 is a flowchart of a process of calculating the location of a vehicle over the length of a prediction time window, according to at least one embodiment of the present disclosure.

FIG. 7 is a flowchart of the process of generating a derived path, according to at least one embodiment of the present disclosure.

FIG. 8 is a schematic block diagram of an illustrative configuration of a computing device that may be used to implement the methods or apparatuses according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components.

The following detailed description, together with the accompanying drawings, is intended to describe exemplary embodiments of the present invention, and is not intended to represent the only embodiments in which the present invention may be practiced.

As used herein, path prediction refers to a function of an autonomous driving system to predict the future path of an autonomous vehicle (subject vehicle).

In the present disclosure, a prediction time window refers to a time interval from the current time to a future time that the autonomous driving system is to predict. The length of the prediction time window may be expressed in units of time. For example, if the autonomous driving system predicts a path from the current time point to a future time point four seconds later, the prediction time window is four seconds long.

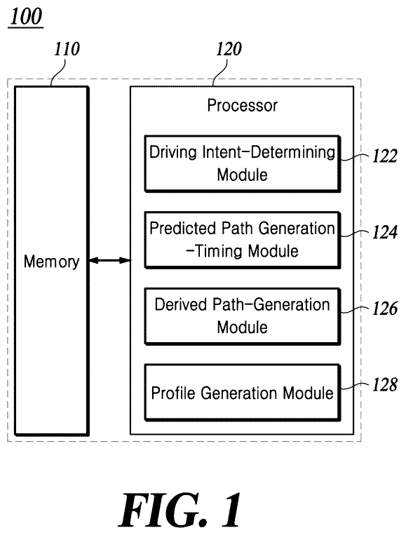

FIG. 1 is a schematic block diagram of a path prediction apparatus 100 according to at least one embodiment of the present disclosure.

The path prediction apparatus 100 includes a memory 110 and a processor 120. The path prediction apparatus 100 may be implemented in the form of an embedded device, a server, an electronic device within an autonomous driving system, or the like. Not all of the blocks illustrated in FIG. 1 are requisite components, and some blocks included in the path prediction apparatus 100 may be added, changed, or deleted. Further, the components illustrated in FIG. 1 represent functionally classified elements, and at least one of the components may be implemented in a form that integrates in a real-world physical environment.

The memory 110 stores data and commands required for the operation of the path prediction apparatus 100.

The memory 110 may store driving information of the vehicle and road information obtained by using at least one sensor included in the vehicle. The vehicle driving information may include a vehicle velocity, acceleration, steering angle, steering angle velocity, heading angle, yaw rate, stepped amount of accelerator/brake pedal, and/or gear shift position. The road information may include lane information. As provided herein, steering angle refers to a measurement of position and turn rate of a steering wheel of the vehicle. Steering angle velocity refers to the rate at which the steering wheel is turned (e.g., a change in steering angle over time). Yaw rate refers to the rate at which the vehicle rotates about its vertical axis, i.e., how quickly the vehicle is turning or rotating from side to side.

The memory 110 may store a predicted path with a physics-based model. The path prediction using the physics-based model predicts the position of the vehicle by applying the obtained driving information to the kinetics-based vehicle trace curvature estimation. The path prediction according to the physics-based model may represent the behavior of the vehicle as a constant curvature. In addition, the memory 110 may store the vehicle's driving information, reference steering angle, and reference steering angle velocity required to calculate the predicted path.

The processor 120 controls the overall operations of the path prediction apparatus 100. The processor 120 may be implemented as one or more processors. The processor 120 may execute instructions stored in the memory 110.

The processor 120 may include a driving intent-determining module 122, a predicted path generation-timing module 124, a derived path-generation module 126, and a profile generation module 128.

The driving intent-determining module 122 may determine the driving intent of the driver based on the driving information of the vehicle stored in the memory 110. The predicted path generation-timing module 124 may determine a predicted path-generation time based on the driving intent of the driver. The derived path-generation module 126 may generate a derived path based on the predicted path-generation time. The profile generation module 128 may generate a velocity profile and a curvature profile for predicting the path of the vehicle based on the driving intent of the driver.

As provided herein, the term “predicted path-generation time” refers to a length of time that is an appropriate length of time to reflect a driver's driving intent, which is determined within the prediction time window.

The driving intent-determining module 122 may determine the driving intent of the driver based on the driving information of the vehicle stored in the memory 110. The driving intent of the driver indicates the intent of the driver to turn the vehicle to a certain extent, to go straight, to turn in the opposite direction, etc. The driver's driving intent may be judged based on vehicle steering angle, steering angle velocity, yaw rate, etc.

The driver's driving intent includes ‘gentle lane regaining’, ‘gentle lane change’, ‘unknown’, ‘abrupt lane change’, and ‘abrupt lane regaining’.

The ‘gentle lane change’ indicates that the driver intends to gently change course to a side lane parallel to the lane in which the driver is currently traveling. The driving intent-determining module 122 determines that the driver's driving intent is a ‘gentle lane change’ if the vehicle steering angle is greater than or equal to a preset first reference steering angle but less than a preset second reference steering angle, and if the vehicle steering angle velocity is greater than or equal to a preset first reference steering angle velocity but less than a preset second reference steering angle velocity. The first reference steering angle, second reference steering angle, first reference steering angle velocity, and second reference steering angle velocity are set based on the steering angle and steering angle velocity that occur if gently changing lanes.

The ‘gentle lane regaining’ indicates the driver's intent to change to a side lane parallel to the lane the driver is currently traveling in and then gently return to the vehicle's original path. The driving intent-determining module 122 determines that the driver's driving intent is ‘gentle lane regaining’ if the vehicle steering angle is equal to or less than a preset third reference steering angle, and the yaw rate of the vehicle and the steering angle of the vehicle are in inverse phase. The vehicle yaw rate and vehicle steering angle being in inverse phase means that the yaw rate is opposite in sign to the steering angle due to a phase delay of yaw rate output. The third reference steering angle is set based on the steering angle that occurs if the driver attempts to change lanes and then gently returns to the vehicle's original path.

The ‘abrupt lane change’ indicates the intent of the driver to abruptly change the path to a side lane parallel to the lane in which the driver is currently traveling. The driving intent-determining module 122 determines that the driver's driving intent is ‘abrupt lane change’ if the vehicle steering angle is greater than or equal to a preset second reference steering angle and the vehicle steering angle velocity is greater than or equal to a preset second reference steering angle velocity.

The ‘abrupt lane regaining’ indicates that the driver intends to change to a side lane parallel to the current lane and then abruptly returns to the original lane. The driving intent-determining module 122 determines that the driver's driving intent is ‘abrupt lane regaining’ if the vehicle steering angle exceeds the preset third reference steering angle, and the vehicle steering angle and the vehicle's steering angle velocity are in inverse phase. The vehicle steering angle and vehicle steering angle velocity being in inverse phase means that the steering angle is opposite in sign to the steering angle velocity due to the phase delay of the steering angle output.

‘Unknown’ indicates a situation that is not lane related driving or a situation where it is difficult to determine the driver's driving intent. Lane related driving means driving in a lane while the driver can perceive thereof. The driving intent-determining module 122 may determine that the driving intent is ‘Unknown’ in a situation where it is difficult to determine whether the driver's current driving intent is a gentle lane change, a gentle lane regaining, an abrupt lane change, or an abrupt lane regaining.

The driving intent-determining module 122 may use a state flow diagram to prevent unintended behavior by the driver. In one example, the lane regaining state may satisfy a precondition of the lane change state. Therefore, a transition from the lane change state to the lane regaining state may occur, but a transition from the unknown state to the lane regaining state may not occur.

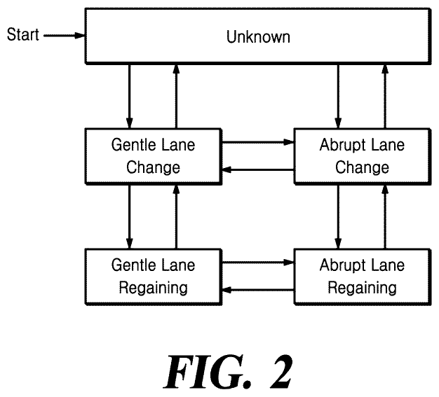

FIG. 2 illustrates an example state flow diagram used by the path prediction apparatus 100 according to at least one embodiment of the present disclosure to determine driving intent.

The driving intent of the driver is unknown at the beginning of the determination thereof.

The driving intent-determining module 122 switches the driving intent from unknown to the gentle lane change if the vehicle steering angle is greater than or equal to the first reference steering angle but less than the second reference steering angle, and if the vehicle steering angle velocity is greater than or equal to the first reference steering angle velocity but less than the second reference steering angle velocity.

Conversely, the driving intent-determining module 122 switches the driving intent from the gentle lane change to unknown if the vehicle steering angle is greater than or equal to the first reference steering angle and greater than or equal to the second reference steering angle, or if the vehicle steering angle velocity is greater than or equal to the first reference steering angle velocity and greater than or equal to the second reference steering angle velocity.

The driving intent-determining module 122 switches the driving intent from unknown to the abrupt lane change if the vehicle steering angle is greater than or equal to the second reference steering angle and the vehicle steering angle velocity is greater than or equal to the second reference steering angle velocity.

Conversely, the driving intent-determining module 122 switches the driving intent from the abrupt lane change to unknown if the vehicle steering angle is less than the second reference steering angle, or if the vehicle steering angle velocity is less than the second reference steering angle velocity.

The driving intent-determining module 122 switches the driving intent from the gentle lane change to the abrupt lane change if the vehicle steering angle is greater than or equal to the second reference steering angle and if the vehicle steering angle velocity is greater than or equal to the second reference steering angle velocity.

Conversely, the driving intent-determining module 122 switches the driving intent from the abrupt lane change to the gentle lane change if the vehicle steering angle is greater than or equal to the first reference steering angle but less than the second reference steering angle, and if the vehicle steering angle velocity greater than or equal to the first reference steering angle velocity but less than the second reference steering angle velocity.

The driving intent-determining module 122 switches the driving intent from the gentle lane change to the gentle lane regaining if the vehicle steering angle is equal to or less than the preset third reference steering angle, and if the vehicle velocity and the vehicle steering angle are in inverse phase.

Conversely, the driving intent-determining module 122 switches the driving intent from the gentle lane regaining to the gentle lane change if the vehicle steering angle is greater than or equal to the first reference steering angle but less than the second reference steering angle, and if the vehicle steering angle velocity is greater than or equal to the first reference steering angle velocity but less than the second reference steering angle velocity.

The driving intent-determining module 122 switches the driving intent from the abrupt lane change to the abrupt lane regaining if the vehicle steering angle exceeds a preset third reference steering angle and if the vehicle steering angle and the vehicle steering angle velocity are in inverse phase.

Conversely, the driving intent-determining module 122 switches the driving intent from the abrupt lane regaining to the abrupt lane change if the vehicle steering angle is greater than or equal to the second reference steering angle and the vehicle steering angle velocity is greater than or equal to the second reference steering angle velocity.

The driving intent-determining module 122 switches the driving intent from the gentle lane regaining to the abrupt lane regaining if the vehicle steering angle is equal to or less than the preset third reference steering angle, and if the vehicle yaw rate and the vehicle steering angle are in inverse phase.

Conversely, the driving intent-determining module 122 switches the driving intent from the abrupt lane regaining to the gentle lane regaining if the vehicle steering angle is equal to or less than the preset third reference steering angle, and if the vehicle yaw rate and the vehicle steering angle are in inverse phase.

The predicted path generation-timing module 124 determines the predicted path-generation time (T_{g,t}) based on the driving intent of the driver. Specifically, the predicted path generation-timing module 124 determines the predicted path-generation time based on the transition condition of the driving intent.

The profile generation module 128 generates a velocity profile and a curvature profile for predicting the path of the vehicle based on the driving intent of the driver.

In the present disclosure, the velocity profile means information representing the velocity of the vehicle over time, and the curvature profile means information representing the curvature of the vehicle trace over time. The velocity profile and the curvature profile may be represented in the form of an array. For example, if the prediction time window is 4 seconds long and the driving velocity or driving curvature is predicted at 0.1-second intervals, the velocity profile or curvature profile may be composed of 41 elements.

The predicted path-generation time (T_{g,t}) may be calculated based on the length (Tₚ) of the prediction time window, the driver's current driving intent, the driver's past driving intent, and the previously determined predicted path-generation time (T_{g,t-1}).

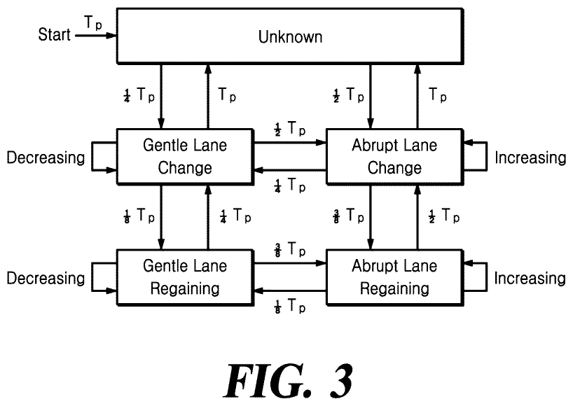

FIG. 3 illustrates an example stateflow diagram used to determine the predicted path-generation time, according to at least one embodiment of the present disclosure.

If the driver's driving intent transitions to the gentle lane change state, the predicted path generation-timing module 124 may change the predicted path-generation time to, for example,

$$\frac{1}{4} {T}_{p} .$$

If the driver's driving intent transitions to the abrupt lane change state, the predicted path generation-timing module 124 may change the predicted path-generation time to, for example,

$$\frac{1}{2} {T}_{p} .$$

If the driver's driving intent transitions to the gentle lane regaining state, the predicted path generation-timing module 124 may change the predicted path-generation time to, for example,

$$\frac{1}{8} {T}_{p} .$$

If the driver's driving intent transitions to the abrupt lane-regaining state, the predicted path generation-timing module 124 may change the predicted path-generation time to, for example,

$$\frac{3}{8} {T}_{p} .$$

If the driver's driving intent transitions to the state of unknown, the predicted path generation-timing module 124 may change the predicted path-generation time to, for example, Tₚ.

Where the driver maintains the driving intent as the gentle lane change, the predicted path generation-timing module 124 may advance the predicted path-generation time by a preset first value from the previously determined predicted path-generation time (T_{g,t-1}).

Where the driver maintains the driving intent as the gentle lane regaining, the predicted path generation-timing module 124 may advance the predicted path-generation time by a preset second value from the previously determined predicted path-generation time (T_{g,t-1}).

The predicted path generation-timing module 124 may reduce the time to reflect the physics-based model by advancing the predicted path-generation time from the gentle lane regaining state or the gentle lane change state. This allows the predicted path that reflects road information to be generated in the gentle lane regaining state or gentle lane change state.

Where the driver maintains the driving intent as the abrupt lane change state, the predicted path generation-timing module 124 may delay the predicted path-generation time by a preset third value from the determined predicted path-generation time (T_{g,t-1}).

Where the driver maintains the driving intent as the abrupt lane regaining, the predicted path generation-timing module 124 may delay the predicted path-generation time by a preset fourth value from the determined predicted path-generation time (T_{g,t-1}).

The predicted path generation-timing module 124 may increase the time to reflect the physics-based model by further delaying the predicted path-generation time from the abrupt lane change state or the abrupt lane regaining state. This allows the predicted path that reflects driving information to be generated in the abrupt lane change state or gentle lane regaining state.

Therefore, the present disclosure can generate a predicted path that reflects road information in the gentle lane change state or gentle lane regaining state, and a predicted path that reflects driving information in the abrupt lane change state or abrupt lane regaining state.

In at least one embodiment of the present disclosure, the driver's driving intent is unknown at the beginning of the determination thereof and the prediction time window is 4 seconds long. If the driving intent transitions from the unknown state to the gentle lane change state, the predicted path-generation time is changed to ¼Tₚ or 1 second. Where the gentle lane change state is maintained, the predicted path-generation time will continue to decrease from 1 second based on the preset first variable.

As another example, if the driving intent transitions from the gentle lane change state to the gentle lane regaining state, the predicted path-generation time is changed to 0.5 seconds or

$$\frac{1}{8} {T}_{p} .$$

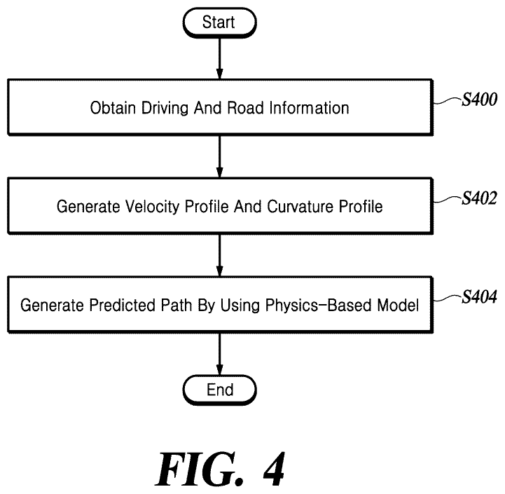

FIG. 4 is a flowchart of a path prediction process using a physics-based model, according to at least one embodiment of the present disclosure.

The path prediction apparatus 100 may obtain driving information of a vehicle by using at least one sensor included in the vehicle (S400). The driving information of the vehicle may include the vehicle's velocity, acceleration, steering angle, steering angle velocity, heading angle, yaw rate, stepped amount of accelerator/brake pedal, and/or gear shift position.

The profile generation module 128 may generate a velocity profile and a curvature profile for path prediction of the vehicle based on the obtained driving information (S402).

The path prediction apparatus 100 may generate a predicted path with a physics-based model based on the generated velocity profile and curvature profile (S404). The path prediction using the physics-based model predicts the location of the vehicle by applying the obtained driving information to the kinematics-based vehicle trace curvature estimation. The path prediction according to the physics-based model may express the behavior of the vehicle as a constant curvature.

Since the path prediction using a physics-based model can predict the path of a vehicle with a value having a single curvature, the path prediction using a physics-based model has the advantage of generating a predicted path while being sensitive to driving information if a prediction time window is relatively short. However, path prediction using a physics-based model is afraid to predict a path that does not reflect the driver's intent if in an abrupt lane change.

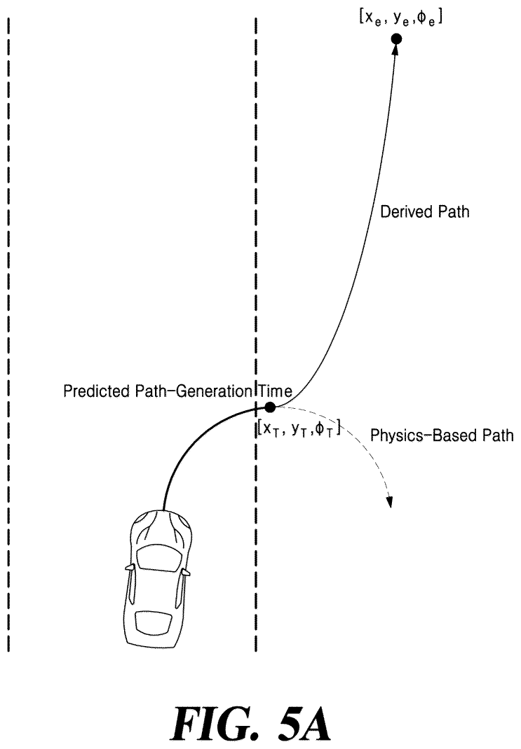

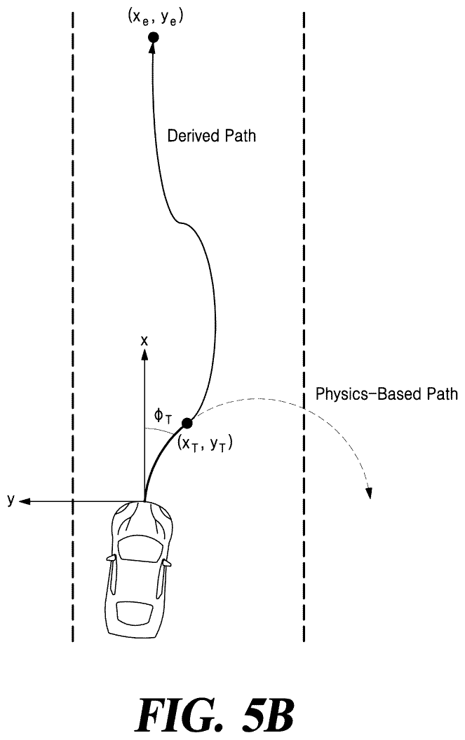

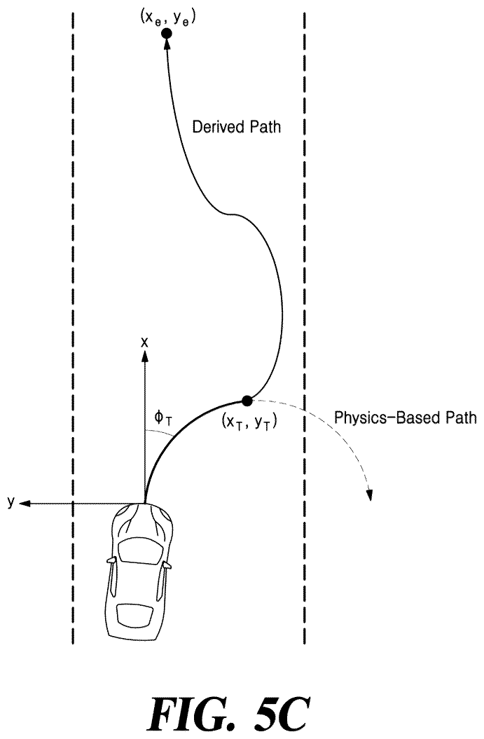

FIGS. 5A, 5B, and 5C are diagrams illustrating derived paths generated by the path prediction apparatus according to at least one embodiment of the present disclosure.

As provided herein, the term “derived path” refers to a path of the vehicle as determined by the path prediction apparatus 100, and thus reflects a driver's driving intent.

FIG. 5A is a diagram illustrating a derived path generated by the path prediction apparatus 100 according to at least one embodiment of the present disclosure. FIG. 5B illustrates an example derived path generated by the path prediction apparatus 100 if the driving intent is the gentle lane regaining. FIG. 5C illustrates an example derived path generated by the path prediction apparatus 100 if the driving intent is the abrupt lane regaining.

The derived path-generation module 126 may set a target point based on the driving intent of the driver. The target point indicates a location [xₑ, yₑ, φₑ] to be reached by the generated predicted path. xₑ is a longitudinal target position, yₑ is a lateral target position, and φₑ is a heading angle of the vehicle.

In at least one embodiment of the present disclosure, the derived path-generation module 126 does not set a target position in an unknown state. The derived path-generation module 126 in the gentle lane change state or abrupt lane change state sets the center point of the target lane to arrive at as the target point of the predicted path. The derived path-generation module 126 in the gentle lane regaining state or abrupt lane regaining state sets the center point of the target lane to maintain as the target point of the predicted path.

The derived path-generation module 126 may set the location [x_{T}, y_{T}, φ_{T}] at the predicted path-generation time on the predicted path obtained with the physics-based model. x_{T} is the longitudinal position at the predicted path-generation time, which is set on the predicted path with the physics-based model. y_{T} is the lateral position at the predicted path-generation time, which is set on the predicted path with the physics-based model. φ_{T} is the heading angle. For example, in the gentle lane change, the position of the vehicle corresponding to the predicted path-generation time, 1 second

$$( \frac{1}{4} {T}_{p} )$$

may be set as the location at the predicted path-generation time.

The derived path-generation module 126 may generate a cubic polynomial curve of the derived path tangentially passing through the location at the predicted path-generation time and the target point. The cubic polynomial curve of the derived path is shown in Equation 1.

$$y = {a}_{3} {x}^{3} + {a}_{2} {x}^{2} + {a}_{1} x + {a}_{0} \qquad [ Equation 1 ]$$

y means the lateral position of the vehicle, and x means the longitudinal position of the vehicle.

The cubic polynomial curve of the derived path tangentially passes through the location at the predicted path-generation time and the target point satisfies Equation 2.

$$[ \begin{matrix}1 & {x}_{T} & {x}_{T}^{2} & {x}_{T}^{3} \\ 0 & 1 & 2 {x}_{T} & 3 {x}_{T}^{2} \\ 1 & {x}_{e} & {x}_{e}^{2} & {x}_{e}^{3} \\ 0 & 1 & 2 {x}_{e} & 3 {x}_{3}^{2}\end{matrix} ] [ \begin{matrix}{a}_{0} \\ {a}_{1} \\ {a}_{2} \\ {a}_{3}\end{matrix} ] = [ \begin{matrix}{y}_{T} \\ {φ}_{T} \\ {y}_{e} \\ {φ}_{e}\end{matrix} ] \qquad [ Equation 2 ]$$

Since the cubic polynomial curve of the derived path tangentially passes through the location at the predicted path-generation time and the target point, the derivative of the cubic polynomial curve at each point should be zero.

The coefficients of the cubic polynomial curve obtained by using Gaussian elimination are as follows.

$$\begin{matrix}{a}_{3} = \frac{( {x}_{e} - {x}_{T} ) ( {φ}_{e} - {φ}_{T} ) - 2 ( {y}_{3} - {y}_{T} )}{{( {x}_{e} - {x}_{T} )}^{3}} \\ {a}_{2} = \frac{{y}_{e} - {y}_{T} - {φ}_{T} ( {x}_{e} - {x}_{T} )}{{( {x}_{e} - {x}_{T} )}^{2}} - ( {x}_{e} + 2 {x}_{T} ) {a}_{3} \\ {a}_{1} = {φ}_{T} - 3 {x}_{T}^{2} {a}_{3} - 2 {x}_{T} {a}_{2} \\ {a}_{0} = {y}_{T} - {x}_{T}^{3} {a}_{3} - {x}_{T}^{2} {a}_{2} - {x}_{T} {a}_{1}\end{matrix} \qquad [ Equation 3 ]$$

Here, a mathematical description of the Gaussian elimination is omitted. The derived path-generation module 126 may obtain the cubic polynomial curve of the derived path by substituting the coefficients obtained by using the Gaussian elimination into the cubic polynomial curve.

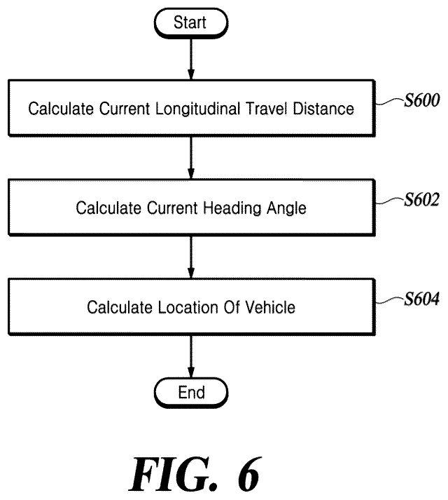

FIG. 6 is a flowchart of a process of calculating the location of a vehicle over the length of a prediction time window, according to at least one embodiment of the present disclosure.

The derived path-generation module 126 may calculate the current longitudinal travel distance based on the velocity profile and heading angle at a previous point in time (S600). In the present disclosure, the velocity profile refers to information indicative of the velocity of the vehicle over time. The heading angle refers to the angle of the vehicle's traveling direction.

The derived path-generation module 126 may calculate the current heading angle based on the cubic polynomial curve of the derived path and the longitudinal travel distance (S602).

The derived path-generation module 126 may calculate the location of the vehicle based on the current heading angle and the current longitudinal travel distance (S604).

The derived path-generation module 126 may repeat the above steps for the length of the prediction time window to continuously update the location and heading of the vehicle. This can improve the accuracy of the predicted path. The derived path-generation module 126 may repeat the derived path-generation process at the updated locations of the vehicle.

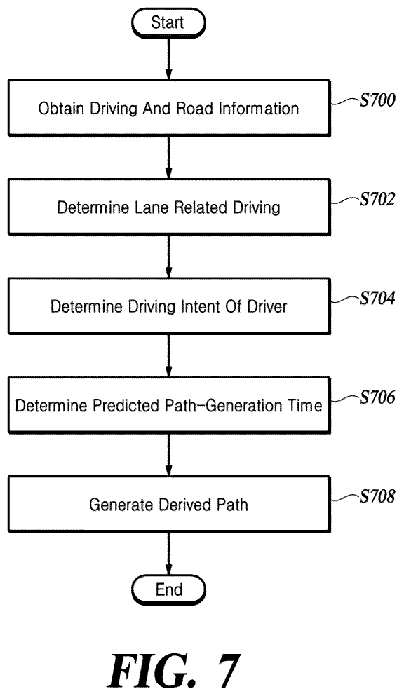

FIG. 7 is a flowchart of the process of generating a derived path, according to at least one embodiment of the present disclosure.

The path prediction apparatus 100 may obtain driving information of the vehicle by using at least one sensor included in the vehicle (S700). For example, the driving information of the vehicle may include vehicle velocity, acceleration, steering angle, steering angle velocity, heading angle, yaw rate, stepped amount of accelerator/brake pedal, and/or gear shift position. And, the path prediction apparatus 100 may obtain road information. For example, the road information may include lane information. The driving information of the vehicle and the road information may be stored in the memory 110.

The path prediction apparatus 100 may determine whether or not the driver is in a lane related driving state (S702). Determining whether or not the driver is in lane related driving means determining whether or not the driver is in a state of being capable of perceiving the lane.

The driving intent-determining module 122 may determine the driving intent of the driver based on the stored driving information of the vehicle (S704). The driving intent of the driver indicates the intent of the driver to turn the vehicle to a certain extent, to go straight, to turn in the opposite direction, etc. The driving intent of the driver may be determined based on the vehicle's steering angle, steering angle velocity, yaw rate, or the like.

The predicted path generation-timing module 124 may determine the predicted path-generation time based on the driving intent of the driver (S706). Specifically, the predicted path generation-timing module 124 may determine the predicted path-generation time based on a transition condition of the driving intent. The predicted path-generation time may be calculated based on the driver's current driving intent, the driver's past driving intent, and the previously determined predicted path-generation time.

The derived path-generation module 126 may generate a derived path based on the predicted path-generation time (S708). The derived path-generation module 126 may set a target point based on the driving intent of the driver. The derived path-generation module 126 may set a vehicle location at the predicted path-generation time on the predicted path obtained with the physics-based model. The derived path-generation module 126 may generate a cubic polynomial curve of the derived path tangentially passing through the vehicle location at the predicted path-generation time and the target point. The derived path-generation module 126 may calculate the current longitudinal travel distance based on the velocity profile and heading angle at a past point in time. The derived path-generation module 126 may calculate the current heading angle based on the cubic polynomial curve of the derived path and the longitudinal travel distance. The derived path-generation module 126 may calculate the location of the vehicle based on the current heading angle and the current longitudinal travel distance.

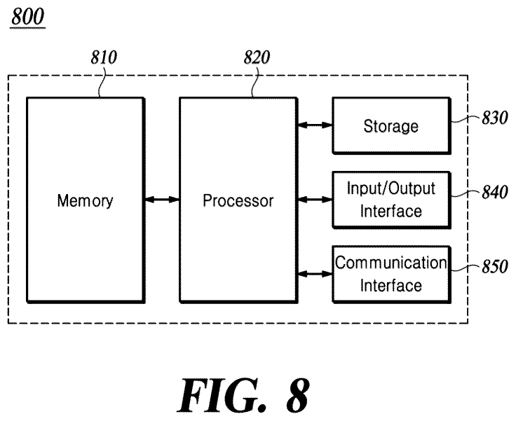

FIG. 8 is a schematic block diagram of an illustrative configuration of a computing device 800 that may be used to implement the methods or apparatuses according to the present disclosure.

The computing device 800 may include some or all of a memory 810, a processor 820, a storage 830, an input/output interface 840, and a communication interface 850. The computing device 800 may be a stationary computing device, such as a desktop computer, server, or the like, as well as a mobile computing device, such as a laptop computer, smartphone, or the like. The computing device 800 may include any specialized hardware accelerator capable of efficiently processing computations on AI models. For example, the computing device 800 may include a graphic processing unit (GPU), a tensor processing unit (TPU), or a neural processing unit (NPU).

The memory 810 may store programs that cause the processor 820 to perform methods or operations under various embodiments of the present disclosure. For example, the program may include a plurality of instructions executable by the processor 820 and the plurality of instructions may be executed by the processor 820 to perform the methods or operations described above. The memory 810 may be a single memory or a plurality of memories. In this case, the information required to perform the methods or operations according to various embodiments of the disclosure may be stored in a single memory or stored divisively among the plurality of memories. When the memory 810 is composed of a plurality of memories, they may be physically separated. The memory 810 may include at least one of volatile memory or non-volatile memory. The volatile memory may include static random access memory (SRAM) or dynamic random access memory (DRAM), for example, and the non-volatile memory may include flash memory, for example.

The processor 820 may include at least one core capable of executing at least one set of instructions. The processor 820 may execute instructions stored in the memory 810. The processor 820 may be a single processor or a plurality of processors.

The storage 830 maintains stored data even when power to the computing device 800 is interrupted. For example, the storage 830 may include non-volatile memory or may include a storage medium such as magnetic tape, optical disk, or magnetic disk. Programs stored in the storage 830 may be loaded into the memory 810 before execution by the processor 820. The storage 830 may store files written in a program language, and programs generated by a compiler or the like may be loaded from the files into the memory 810. The storage 830 may store data to be processed by the processor 820 and/or data that has been processed by the processor 820.

The input/output interface 840 may provide an interface with an input device, such as a keyboard, mouse, etc. and/or with an output device, such as a display device, printer, etc. A user can trigger the execution of a program by the processor 820 via the input device and/or view the results of processing by the processor 820 via the output device.

The communication interface 850 may provide access to an external network. The computing device 800 may communicate with other devices via the communication interface 850.

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. A method for predicting a path of a vehicle, the method comprising:
obtaining, by at least one processor, road information and driving information of the vehicle;
determining, by the at least one processor, a driving intent of a driver based on at least one of a steering angle, a steering angle velocity, or a yaw rate of the vehicle;
determining, by the at least one processor, a predicted path-generation time based on the driving intent of the driver; and
generating, by the at least one processor, a derived path based on the predicted path-generation time.

2. The method of claim 1, wherein determining the driving intent of the driver comprises determining the driving intent of the driver to be a first driving intent if the steering angle is greater than or equal to a preset first reference steering angle and less than a preset second reference steering angle, and if the steering angle velocity is greater than or equal to a preset first reference steering angle velocity and less than a preset second reference steering angle velocity,
wherein the first driving intent indicates an intent of the driver to make a gentle path change.

3. The method of claim 1, wherein determining the driving intent of the driver comprises determining the driving intent of the driver to be a second driving intent if the steering angle is equal to or less than a preset third reference steering angle and the yaw rate is opposite in sign to the steering angle,
wherein the second driving intent indicates an intent of the driver to perform a gentle path regaining.

4. The method of claim 1, wherein determining the driving intent of the driver comprises determining the driving intent of the driver to be a third driving intent if the steering angle is greater than or equal to a preset second reference steering angle and the steering angle velocity is greater than or equal to a preset second reference steering angle velocity,
wherein the third driving intent indicates an intent of the driver to make an abrupt path change.

5. The method of claim 1, wherein determining the driving intent of the driver comprises determining the driving intent of the driver to be a fourth driving intent if the steering angle is greater than a preset third reference steering angle and the steering angle is opposite in sign to the steering angle velocity,
wherein the fourth driving intent indicates an intent of the driver to make an abrupt path regaining.

6. The method of claim 1, wherein determining the predicted path-generation time comprises changing the predicted path-generation time in response to a transition in the driving intent of the driver.

7. The method of claim 1, wherein determining the predicted path-generation time comprises changing the predicted path-generation time in response to the driving intent of the driver being maintained.

8. The method of claim 1, wherein generating the derived path comprises setting a target point based on the driving intent of the driver.

9. The method of claim 1, wherein the derived path is a cubic polynomial curve tangentially passing through location coordinates of a target point and the location coordinates at the predicted path-generation time.

10. An apparatus for predicting a path of a vehicle, comprising:
at least one memory configured to store instructions; and
at least one processor,
wherein the at least one processor is configured to execute the instructions stored in the at least one memory for causing the processor to:
obtain road information and driving information of the vehicle;
determine a driving intent of a driver based on at least one of a steering angle, a steering angle velocity, or a yaw rate of the vehicle;
determine a predicted path-generation time based on the driving intent of the driver; and
generate a derived path based on the predicted path-generation time.

11. The apparatus of claim 10, wherein determining the driving intent of the driver comprises determining the driving intent of the driver to be a first driving intent if the steering angle is greater than or equal to a preset first reference steering angle and less than a preset second reference steering angle, and if the steering angle velocity is greater than or equal to a preset first reference steering angle velocity and less than a preset second reference steering angle velocity,
wherein the first driving intent indicates an intent of the driver to make a gentle path change.

12. The apparatus of claim 10, wherein determining the driving intent of the driver comprises determining the driving intent of the driver to be a second driving intent if the steering angle is equal to or less than a preset third reference steering angle and the yaw rate is opposite in sign to the steering angle,
wherein the second driving intent indicates an intent of the driver to perform a gentle path regaining.

13. The apparatus of claim 10, wherein determining the driving intent of the driver comprises determining the driving intent of the driver to be a third driving intent if the steering angle is greater than or equal to a preset second reference steering angle and the steering angle velocity is greater than or equal to a preset second reference steering angle velocity,
wherein the third driving intent indicates an intent of the driver to make an abrupt path change.

14. The apparatus of claim 10, wherein determining the driving intent of the driver comprises determining the driving intent of the driver to be a fourth driving intent if the steering angle is greater than a third reference steering angle and the steering angle is opposite in sign to the steering angle velocity,
wherein the fourth driving intent indicates an intent of the driver to make an abrupt path regaining.

15. The apparatus of claim 10, wherein determining the predicted path-generation time comprises changing the predicted path-generation time in response to a transition in the driving intent of the driver.

16. The apparatus of claim 10, wherein determining the predicted path-generation time comprises changing the predicted path-generation time in response to the driving intent of the driver being maintained

17. The apparatus of claim 10, wherein generating the derived path comprises setting a target point based on the driving intent of the driver.

18. The apparatus of claim 10, wherein the derived path is a cubic polynomial curve tangentially passing through location coordinates of a target point and the location coordinates at the predicted path-generation time.

19. A vehicle comprising the apparatus of claim 10.

20. A non-transitory computer readable medium containing program instructions executed by a processor, the computer readable medium comprising:
program instructions that obtain road information and driving information of a vehicle;
program instructions that determine a driving intent of a driver based on at least one of a steering angle, a steering angle velocity, or a yaw rate of the vehicle;
program instructions that determine a predicted path-generation time based on the driving intent of the driver; and
program instructions that generate a derived path based on the predicted path-generation time.
